(19) United States
(12) Patent Application Publication
(10) Pub. No.: US 2013/0266729 A1
(43) Pub. Date: Oct. 10, 2013

(54) METHOD FOR MAKING STRIP SHAPED GRAPHENE LAYER

(71) Applicants: TSINGHUA UNIVERSITY, Beijing (CN); HON HAI PRECISION INDUSTRY CO., LTD., New Taipei (TW)

(72) Inventors: XIAO-YANG LIN, Beijing (CN); KAI-LI JIANG, Beijing (CN); SHOU-SHAN FAN, Beijing (CN)

(73) Assignees: HON HAI PRECISION INDUSTRY CO., LTD., New Taipei (TW); TSINGHUA UNIVERSITY, Beijing (CN)

(21) Appl. No.: 13/730,858

(22) Filed: Dec. 29, 2012

(30) Foreign Application Priority Data
Apr. 5, 2012 (CN) 201210096862.X

(51) Int. Cl. C01B 31/04

(52) U.S. Cl. CPC C01B 31/0446
USPC 427/265

(57) ABSTRACT

A method for making a strip shaped graphene layer includes the following steps. First, a carbon nanotube structure on a surface of a metal substrate is provided. The carbon nanotube structure includes at least one drawn carbon nanotube film. The at least one drawn carbon nanotube film includes carbon nanotube segments substantially parallel to each other and separated from each other by a strip-shaped gap. Second, a catalyst layer is disposed on the carbon nanotube structure, and parts of the catalyst layer are contacted to the surface of the substrate in the strip-shaped gaps. Third, the carbon nanotube structure is removed to obtain s plurality of catalyst strips on the surface of the substrate. Fourth, graphene strips are grown on the number of catalyst strips. Third, the metal substrate is annealed to obtain the strip shaped graphene layer.

### CROSS-REFERENCE TO RELATED APPLICATIONS

This application claims all benefits accruing under 35 U.S.C. §119 from China Patent Application No. 201210096862.X, filed on Apr. 5, 2012, in the China Intellectual Property Office, the contents of which are hereby incorporated by reference.

### BACKGROUND

1. Technical Field

The present disclosure relates to a method for making a strip shaped graphene layer.

2. Description of Related Art

Graphene is an allotrope of carbon with a structure of one-atom-thick planar sheets of sp²-bonded carbon atoms that are densely packed in a honeycomb crystal lattice. Graphene can be most easily visualized as an atomic-scale chicken wire made of carbon atoms and their bonds. The crystalline or “flake” form of graphite consists of many graphene sheets stacked together.

The carbon-carbon bond length in graphene is about 0.142 nanometers. Graphene sheets stack to form graphite with an interplanar spacing of 0.335 nanometers. Graphene is a basic structural element of some carbon allotropes including graphite, charcoal, carbon nanotubes, and fullerenes. It can also be considered as an indefinitely large aromatic molecule, and the limiting case of the family of flat polycyclic aromatic hydrocarbons.

Graphene has excellent electrical and thermal properties. An electron mobility of graphene at room temperature is about 15000 cm²V⁻¹s⁻¹. A thermal conductivity of the graphene is about 3000 Wm⁻¹K⁻¹. Graphene can be used on the semiconductor devices, such as, sensors, transistors, solar cells, thin film transistors, and so on. In such applications, a strip shaped graphene layer is needed.

What is needed, therefore, is to provide a method for making a strip shaped graphene layer.

### BRIEF DESCRIPTION OF THE DRAWING

Many aspects of the present disclosure can be better understood with reference to the following drawings. The components in the drawings are not necessarily to scale, the emphasis instead being placed upon clearly illustrating the principles of the present embodiments.

FIG. 1 shows a flowchart of one embodiment of a method for making a strip shaped graphene layer.

FIG. 2 shows a number of cross-sectional views of the method for making the strip shaped graphene layer in FIG. 1.

FIG. 3 is a structural view of a carbon nanotube structure used in the method of FIG. 1.

FIG. 4 is a scanning electron microscopic (SEM) image of a drawn carbon nanotube film of the carbon nanotube structure in FIG. 3.

FIG. 5 is a schematic view of a method for making the drawn carbon nanotube film in FIG. 4.

FIG. 6 is a schematic view of a plurality of catalyst strips formed in step S3 of the method in FIG. 1.

FIG. 7 is a schematic view of one strip shaped graphene layer obtained by the method of FIG. 1.

FIG. 8 is a schematic view of another strip shaped graphene layer obtained by the method of FIG. 1.

### DETAILED DESCRIPTION

The disclosure is illustrated by way of example and not by way of limitation in the figures of the accompanying drawings in which like references indicate similar elements. It should be noted that references to “another,” “an,” or “one” embodiment in this disclosure are not necessarily to the same embodiment, and such references mean at least one.

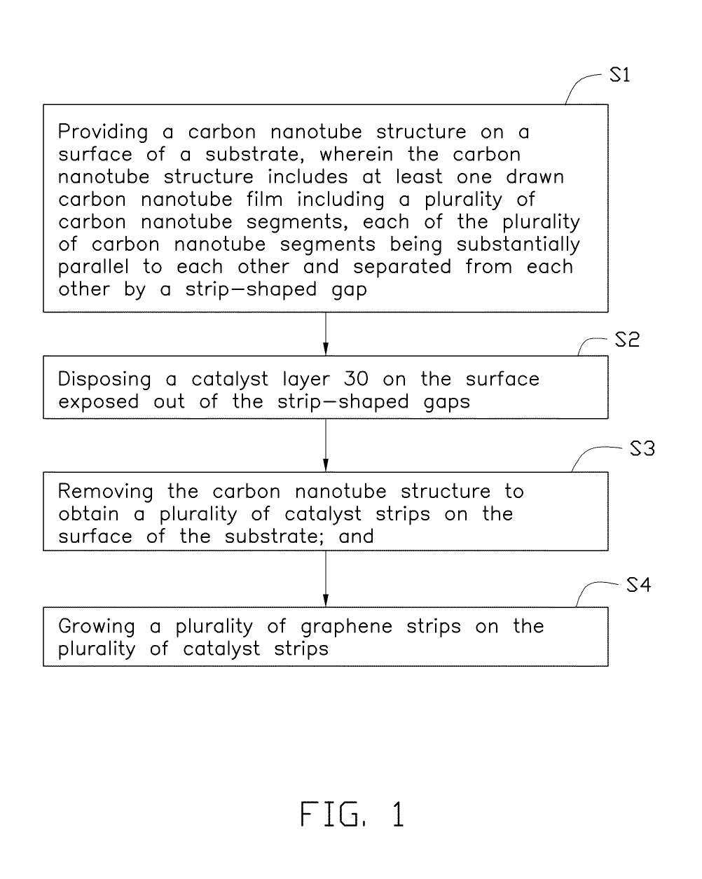

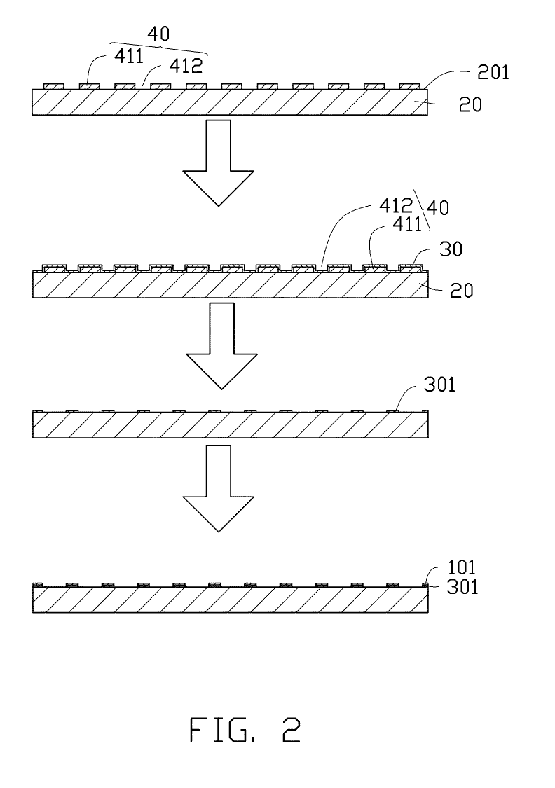

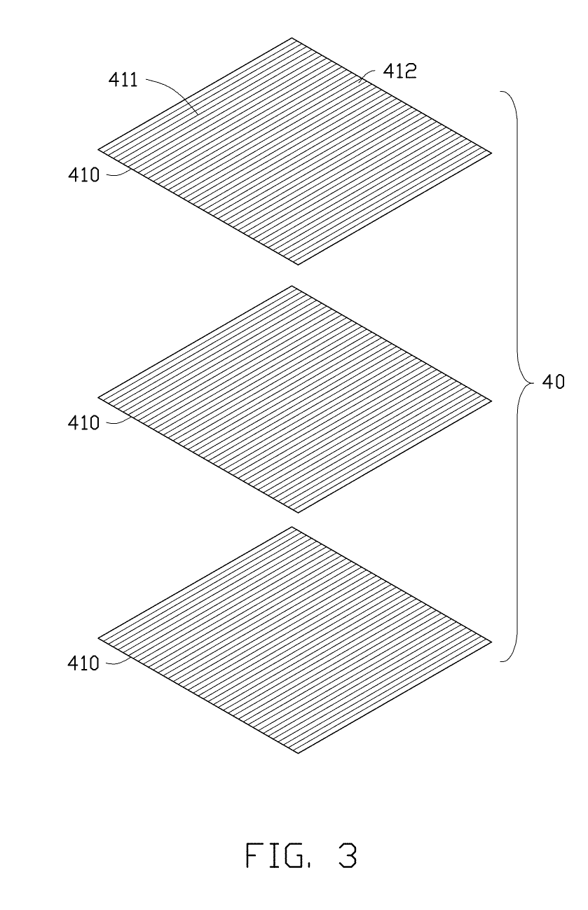

Referring to FIG. 1, FIG. 2 and FIG. 3, one embodiment of a method for making a strip shaped graphene layer 10 includes:

S1, providing a carbon nanotube structure 40 on a surface 201 of a substrate 20, wherein the carbon nanotube structure 40 includes at least one drawn carbon nanotube film 410 including a plurality of carbon nanotube segments 411, each of the plurality of carbon nanotube segments 411 being substantially parallel to each other and separated from each other by a strip-shaped gap 412;

S2, disposing a catalyst layer 30 on the surface 201 exposed out of the strip-shaped gaps 412;

S3, removing the carbon nanotube structure 40 to obtain a plurality of catalyst strips 301 on the surface 201 of the substrate 20; and

S4, growing a plurality of graphene strips 101 on the plurality of catalyst strips 301.

In step S1, the substrate 20 has a sheet structure, and can be a made of silicon, silicon dioxide, silicon carbide, quartz or glass. A thickness in a range from about 100 nanometers to about 1000 micrometers. An area of the substrate 20 can be set according to the volume of the chamber used to grow the graphene strips 101 by a chemical vapor deposition (CVD) method. In one embodiment, the substrate 20 is a Monocrystalline Wafer with a thickness of about 25 micrometers.

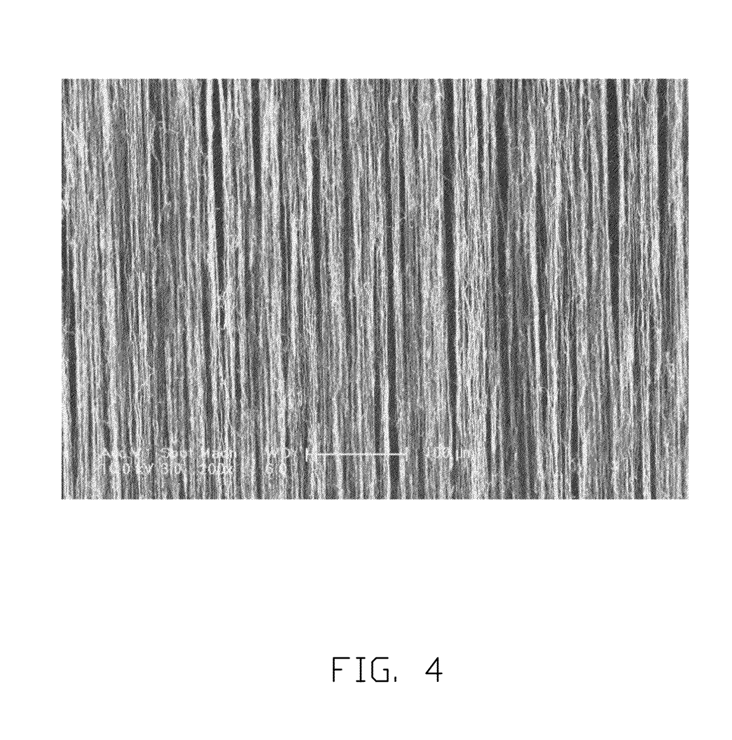

The carbon nanotube structure 40 can include one drawn carbon nanotube film 410 or a plurality of drawn carbon nanotube films 410 stacked with each other. Referring to FIG. 3, in one embodiment, the carbon nanotube structure 40 includes three of the drawn carbon nanotube films 410 stacked with each other, and the carbon nanotubes in each of the drawn carbon nanotube films 410 are aligned along a same direction. Referring to FIG. 4, the drawn carbon nanotube film 410 includes the plurality of carbon nanotube segments 411 substantially parallel to each other, and the plurality of strip-shaped gaps 412 between adjacent ones of the carbon nanotube segments 411. Each of the plurality of carbon nanotube segments 411 includes a plurality of successive and oriented carbon nanotubes joined end-to-end by van der Waals attractive force therebetween. Thus, the carbon nanotubes in the drawn carbon nanotube film 410 are aligned along a same direction and substantially parallel to a surface of the drawn carbon nanotube film 410. A thickness of the drawn carbon nanotube film 410 can be in a range from about 0.5 nanometers to about 100 micrometers. A width of the plurality of strip-shaped gaps 412 can range from about 10 nanometers to about 100 nanometers.

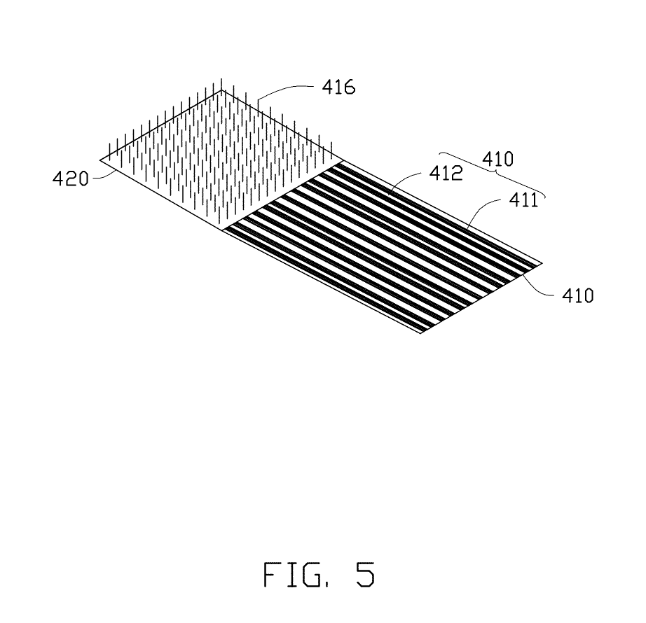

Referring to FIG. 5, the drawn carbon nanotube film 410 can be formed by drawing a film from a carbon nanotube array 416 that is capable of having a film drawn therefrom by using a pulling/drawing tool.

The carbon nanotube array 416 can be formed by a CVD method. The carbon nanotube array 416 is formed on a substrate 420, and includes a plurality of carbon nanotubes substantially perpendicular to the surface 201 of the substrate 420. The carbon nanotubes together form the carbon nanotube array 416 located on the surface of the substrate 420. The carbon nanotube array 416 is essentially free of impurities such as carbonaceous or residual catalyst particles. The carbon nanotubes in the carbon nanotube array 416 are closely packed together by van der Waals attractive force. Accordingly, the drawn carbon nanotube film 410 can be drawn from the carbon nanotube array 416. The length of the carbon nanotubes can be approximately 50 microns to approximately 5 millimeters. In one embodiment, the length of the carbon nanotubes can be approximately ranged from 100 microns to 900 microns. The method for growing the carbon nanotube array 416 is disclosed by patent application US20080248235 to Feng et al.

The pulling/drawing tool can be adhesive tape, pliers, tweezers, or any tool capable of gripping and simultaneously pulling multiple carbon nanotubes. The drawn carbon nanotube film 410 can be pulled/drawn out from the carbon nanotube array 416 by the following steps:

selecting the carbon nanotube segments 411 having a predetermined width from the carbon nanotube array 416; and

pulling the carbon nanotube segments 411 at an even/uniform speed to achieve the drawn carbon nanotube film 410 which is uniform.

The carbon nanotube array 416 is capable of having a film drawn therefrom. The carbon nanotube segments 411 having a predetermined width can be selected by using an adhesive tape such as the pulling/drawing tool to contact the carbon nanotube array 416. The carbon nanotube segments 411 include a plurality of carbon nanotubes substantially parallel to each other. The pulling direction is arbitrary (e.g., substantially perpendicular to the growing direction of the carbon nanotube array).

Specifically, during the pulling/drawing process, as the initial carbon nanotube segments 411 are drawn out, other carbon nanotube segments 411 are also drawn out end-to-end due to the van der Waals attractive force between ends of adjacent segments. In general, the initially selected carbon nanotubes are drawn out from the carbon nanotube array 416 by the moving of the drawing tool. The following carbon nanotubes adjacent to the initially selected carbon nanotubes are then drawn out by van der Waals attractive force between the following carbon nanotubes and the initially selected carbon nanotubes thereby forming the drawn carbon nanotube film 410 with the carbon nanotubes joined end-to-end by van der Waals attractive force therebetween. This process of drawing ensures that a continuous, uniform, and free-standing drawn carbon nanotube film 410 having a predetermined width can be formed.

A width of the drawn carbon nanotube film 410 depends on the size of the carbon nanotube array 416. A length of the drawn carbon nanotube film 410 is arbitrary. In one embodiment, if the size of the substrate is 4 inches, the width of the drawn carbon nanotube film 410 is in the approximate range from 1 centimeter to 10 centimeters, and the thickness of the drawn carbon nanotube film 410 is in the approximate range from 0.01 microns to about 100 microns.

The carbon nanotube structure 40 can be formed by the following steps:

providing a frame and adhering first one of the drawn carbon nanotube films 410 to the frame and removing the excess film outside the frame;

adhering second one of the drawn carbon nanotube films 410 to the frame to overlap the first one drawn carbon nanotube film 410, wherein the carbon nanotubes of the first one and the second drawn carbon nanotube films 410 are aligned a long a same direction; and

repeating the above steps thereby forming the carbon nanotube structure 40.

For example, two or more such drawn carbon nanotube films 410 can be stacked on each other on the frame to form the carbon nanotube structure 40. The carbon nanotubes in every two adjacent drawn carbon nanotube films 410 are aligned along a same direction.

Because the drawn carbon nanotube film 410 includes the plurality of strip-shaped gaps 411 between adjacent one of the carbon nanotube segments 411, the strip-shaped gaps 412 of the adjacent drawn carbon nanotube films 410 can stack with each other in the carbon nanotube structure 40. The width of the plurality of strip-shaped gaps 412 in the carbon nanotube structure 40 can be controlled by adjusting the number of the stacked drawn carbon nanotube films 410. The width of the plurality of strip-shaped gaps 412 can range from about 10 nanometers to about 100 nanometers. In one embodiment, the width of the plurality of strip-shaped gaps 412 is in a range from about 50 nanometers to about 80 nanometers.

To increase the dimension of the strip-shaped gaps 412 in the carbon nanotube structure 40, the carbon nanotube structure 40 can be treated with an organic solvent.

The carbon nanotube structure 40 can, beneficially, be treated by either of two methods: dropping the organic solvent from a dropper to soak the entire surface of the carbon nanotube structure 40 fixed on a frame or a surface of a supporter, or immersing the frame with the carbon nanotube structure 40 thereon into a container having an organic solvent therein. After being soaked by the organic solvent, the carbon nanotube segments 411 in the drawn carbon nanotube film 410 of the carbon nanotube structure 40 can at least partially shrink and collect or bundle together.

The carbon nanotubes in the drawn carbon nanotube film 410 of the carbon nanotube structure 40 are joined end to end and aligned along a same direction, thus the carbon nanotube segments 411 would shrink in a direction perpendicular to the orientation of the carbon nanotubes. If the drawn carbon nanotube film 410 is fixed on a frame or a surface of a supporter or a substrate, the carbon nanotube segments 411 would shrink into several large carbon nanotube bundles. A distance between the adjacent large carbon nanotube bundles is increased after the above treatment. As such, the dimension of the strip-shaped gaps 412 is increased and can be in a range from about 2 micrometers to about 200 micrometers. Due to the decrease of the specific surface via bundling, the coefficient of friction of the carbon nanotube structure 40 is reduced, but the carbon nanotube structure 40 maintains high mechanical strength and toughness.

The organic solvent is volatilizable and can be ethanol, methanol, acetone, dichloroethane, chloroform, or any combinations thereof.

To increase the dimension of the strip-shaped gaps 412 in the carbon nanotube structure 40, the drawn carbon nanotube films 410 can be treated by a laser beam before stacking with each other to form the carbon nanotube structure 40.

The laser beam treating method includes fixing the drawn carbon nanotube film 410 and moving the laser beam at an even/uniform speed to irradiate the drawn carbon nanotube film 410, thereby increasing the width of the plurality of strip-shaped gaps 412. A laser device used in this process can have a power density greater than 0.1×10⁴ W/m².

The laser beam is moved along a direction in which the carbon nanotubes are oriented. The carbon nanotubes absorb energy from laser irradiation and the temperature thereof is increased. Some of the carbon nanotubes in the drawn carbon nanotube film 410 will absorb more energy and be destroyed. When the carbon nanotubes along the orientation of the carbon nanotues in the drawn carbon naotube film 410 are destroyed due to absorbing too much energy from the laser irradiation, the width of the trip gaps 412 can be in a range from about 2 micrometers to about 200 micrometers.

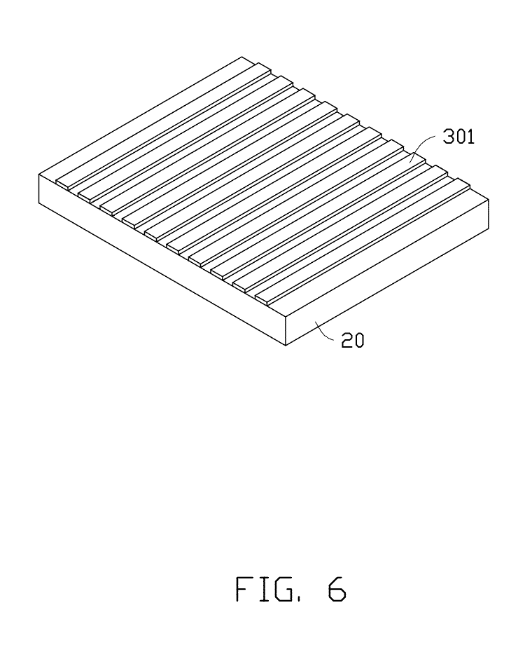

The carbon nanotube structure 40 is used as a mask to make the material of the catalyst layer 30 covering the surface 201 exposed out of the strip-shaped gaps 412 and the carbon nanotube structure 40. A plurality of catalyst strips 301, corresponding to the strip-shaped gaps 412, on the surface 201 of the substrate 20 can be formed after removing the carbon nanotube structure 40, as shown in FIG. 6. The size of the strip-shaped gaps 412 in the carbon nanotube structure 40 can be readily adjusted according to need. Thus, the size of the catalyst strips 301 can be adjusted. Further, the carbon nanotube structure 40 can be integrally moved out of the substrate 20, leaving the catalyst strips 301 on the surface 201 of the substrate 20, because the carbon nanotube structure 40 has a self-supporting characteristic. Finally, the carbon nanotube structure 40 has a simple preparation method, low production cost, and manufacturing efficiency advantages.

In step S2, the catalyst layer 30 can be formed by a sputtering method or evaporating method. The material of the catalyst layer 30 can be copper (Cu), nickel (Ni), iridium (Ir), ruthenium (Ru), or molybdenum (Mo). In one embodiment, the material of the catalyst layer 30 is Cu. Further, to improve the wettability between the Cu and the substrate 20, a nickel layer can be disposed on the surface 201 first, and then the Cu layer is formed on the nickel layer. A thickness of the catalyst layer 30 can be in a range from about 10 nanometers to about 500 nanometers. In one embodiment, the thickness of the catalyst layer 30 is in a range from about 300 nanometers to about 500 nanometers. In one embodiment, the catalyst layer 30 is obtained by a thermal evaporation method, the vacuum degree of the chamber is in a range from 1×10⁻⁶ Pa to 1×10⁻¹ Pa, the deposition rate is in a range from about 0.5 Å/sec (angstroms per second) to about 50 Å/sec. In another embodiment, the catalyst layer 30 is obtained by a sputtering method, the vacuum degree of the chamber is in a range from about 1×10⁻⁵ Pa to about 1 Pa, the sputtering power is in a range from about 5 W/cm² (watts per square centimeter) to about 15 W/cm², and the deposition rate is in a range from about 0.5 Å/sec (angstroms per second) to about 50 Å/sec.

In step S3, the carbon nanotube structure 40 is a self-supporting structure, and can be removed directly by a mechanical method, such as pulling, tearing, or brushing. The parts of the catalyst layer 30 covering the carbon nanotube segments 411 can be removed with the carbon nanotube structure 40. Thus, the parts of the catalyst layer 30 contacting the surface 201 of the substrate 20 exposed out of the strip-shaped gaps 411 is left on the surface 201, and a plurality of catalyst strips 301 is formed. Furthermore, to separate the carbon nanotube structure 40 with the substrate 20, an ultrasonic treating process can be used. The duration of the ultrasonic treating process can be in a range from about 3 minutes to about 30 minutes. In one embodiment, the carbon nanotube structure 40 on the substrate 20 is treated by the ultrasonic treating process for 10 minutes.

In step S4, the plurality of graphene strips 101 is formed by a CVD method, a reacting chamber, the step S4 includes the substeps of:

S41, placing the substrate 20 in a reacting chamber;

S42, heating the substrate 20 to a predetermined temperature; and

S43, flowing a carbon source gas into the reacting chamber, thereby forming the graphene strips 101 on a surface of the catalyst strip 301.

In step S41, the reacting chamber can provide a reaction space for growing the graphene strips 101. The reacting chamber can have a sealed cavity. The reacting chamber includes a gas inlet and a gas outlet. The gas inlet is used to input a reaction gas. The gas outlet is connected with an evacuating device. The evacuating device can be used to adjust the pressure in the reacting chamber. Furthermore, the reacting chamber can include a water cooling device to adjust the temperature in the reacting chamber. The reacting chamber can be a quartz tube furnace. An area of the substrate 20 can be adjusted according to the volume of the reacting chamber.

In step S42, the surface of the catalyst strips 301 is heated to become more flat. The flatter the surface of the catalyst strips 301, the easier to form the graphene strips 101 on the surface of catalyst strips 301. The reacting chamber is evacuated before heating the metal substrate. In one embodiment, hydrogen gas can be imported in the reacting chamber through the gas inlet before heating the metal substrate. The hydrogen gas can reduce an oxide layer on the surface of the catalyst strips 301, and can further prevent the surface of the catalyst strips 301 from oxidizing. A flow rate of the hydrogen gas can be in a range from about 2 standard cubic centimeters per minute (sccm) to about 35 sccm. A heating temperature can be in a range from about 800° C. to about 1500° C. A heating period can be in a range from about 20 minutes to about 60 minutes. A pressure in the reacting chamber can be in a range from about 0.1 Pa to about 100 Pa. In one embodiment, the flow rate of the hydrogen gas is about 2 sccm, the pressure of the reacting chamber is about 13.3 Pa, the heating temperature is about 1000° C., a temperature rising period is about 40 minutes, and the constant temperature period at the heating temperature is about 20 minutes.

In step S43, carbon atoms can be deposited on the surface of the catalyst strips 301, thereby forming the graphene strips 101 composed of carbon atoms. The hydrogen gas is continuously imported through the gas inlet in step S43 during the process of growing the graphene strips 101. The flow rate of the hydrogen gas, while supplying the carbon source gas into the reacting chamber, is the same as the flow rate in the step S42. A ratio between the flow rate of the carbon source gas and the hydrogen gas is in a range from about 45:2 to about 15:2. The carbon source gas can be at least one of methane, ethane, ethylene, and acetylene. While supplying the carbon source gas, the temperature in the reacting chamber can be in a range from about 800° C. to about 1500° C. with a constant temperature period in a range from about 10 minutes to about 60 minutes. A pressure in the reacting chamber can be in a range from about 10⁻¹ Pa to about 10² Pa. In one embodiment, the pressure of the reacting chamber is about 66.5 Pa, the temperature of the reacting chamber is about 1000° C., the flow rate of the carbon source gas is about 25 sccm, the carbon nanotube gas is methane, and the constant temperature period is about 30 minutes.

In step S43, the substrate 20 can be cooled after forming the graphene strips 101 thereon. While cooling the substrate 20, the carbon source gas and the hydrogen gas can be continuously flowed into the reacting chamber. The flow rate of the carbon source gas and the hydrogen gas and the pressure of the reacting chamber are constant. In one embodiment, the metal substrate is cooled for about 1 hour. After cooling, the substrate 20 with the graphene strips 101 grown thereon is taken out of the reacting chamber.

Furthermore, the strip shaped graphene layer 10 formed by above method can be transferred to other substrates according to actually needs.

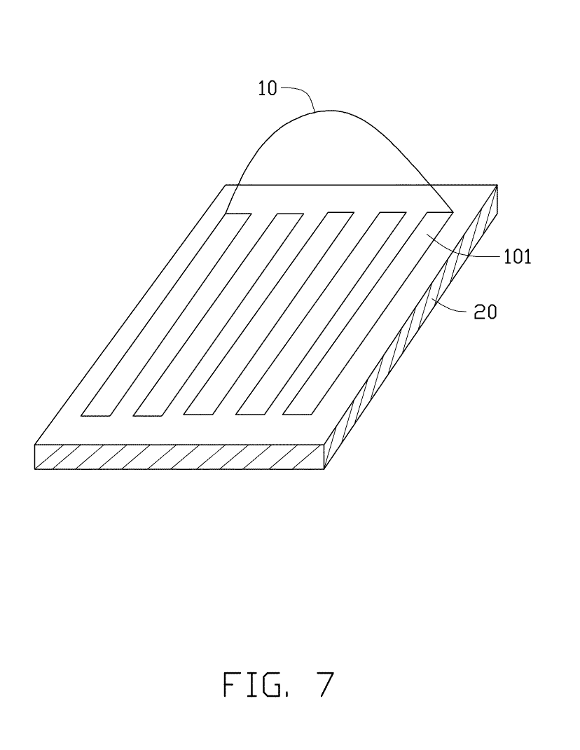

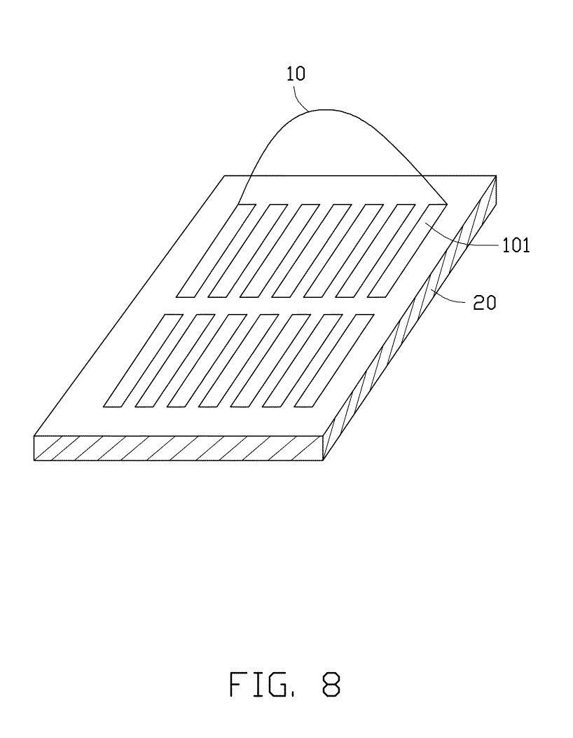

As shown in FIG. 7 and FIG. 8, a strip shaped graphene layer 10 is located on the substrate. The strip shaped graphene layer 10 includes a plurality of graphene strips 101 aligned along a same direction and substantially parallel to each other. The strip shaped graphene layer 10 can be used as conductive layers in semi-conductive devices. Each of the plurality of graphene strips 101 is corresponding to one of the strip carbon ion zone 100.

Depending on the embodiment, certain steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

Finally, it is to be understood that the above-described embodiments are intended to illustrate rather than limit the present disclosure. Variations may be made to the embodiments without departing from the spirit of the present disclosure as claimed. Elements associated with any of the above embodiments are envisioned to be associated with any other embodiments. The above-described embodiments illustrate the scope of the present disclosure but do not restrict the scope of the present disclosure.

What is claimed is:

1. A method for making a strip shaped graphene layer comprising:
S1, providing a carbon nanotube structure on a surface of a substrate, wherein the carbon nanotube structure comprises at least one drawn carbon nanotube film comprising a plurality of carbon nanotube segments, each of the plurality of carbon nanotube segments is substantially parallel to each other and separated from each other by a strip-shaped gap, and there is at least one strip-shaped gap;
S2, disposing catalyst material on the surface exposed out of the strip-shaped gaps;
S3, removing the carbon nanotube structure to obtain a plurality of catalyst strips on the surface of the substrate; and
S4, growing a plurality of graphene strips on the plurality of catalyst strips.

2. The method of claim 1, wherein in step S1, the substrate has a thickness in a range from about 100 nanometers to about 100 micrometers.

3. The method of claim 2, wherein the substrate is made of silicon, silicon dioxide, silicon carbide, quartz, or glass.

4. The method of claim 1, wherein a width of the at least one strip-shaped gap is in a range from about 20 nanometers to about 80 nanometers.

5. The method of claim 1, wherein the at least one drawn carbon nanotube film of the carbon nanotube structure comprises a plurality of drawn carbon nanotube films stacked with each other.

6. The method of claim 5, wherein each of the plurality of drawn carbon nanotube films is made by:
providing a carbon nanotube array;
selecting a carbon nanotube segment having a predetermined width from the carbon nanotube array; and
pulling the carbon nanotube segment at a uniform speed to form one of the at least one drawn carbon nanotube films which is uniform.

7. The method of claim 1, wherein in step S2, the catalyst material is copper (Cu), nickel (Ni), iridium (Ir), ruthenium (Ru), or molybdenum (Mo).

8. The method of claim 7, wherein in step S2, the catalyst material is disposed on the surface of the substrate exposed out of the at least onestrip-shaped gap by a sputtering or evaporating method.

9. The method of claim 1, wherein the plurality of catalyst strips has the same pattern as the at least one strip-shaped gap.

10. The method of claim 1, wherein step S4 comprises:
S41, placing the substrate in a reacting chamber;
S42, heating the substrate to a predetermined temperature; and
S43, flowing a carbon source gas into the reacting chamber, thereby forming the graphene strips on a surface of the catalyst strip.

11. A method for making a strip shaped graphene layer comprising:
S1, providing a carbon nanotube structure on a surface of a substrate, wherein the carbon nanotube structure comprises at least one drawn carbon nanotube film comprising a plurality of carbon nanotube segments, each of the plurality of carbon nanotube segments is substantially parallel to each other and separated from each other by a strip-shaped gap, and there are a plurality of strip-shaped gaps;
S2, coating a catalyst layer on the carbon nanotube structure, wherein parts of the catalyst layer contacts to the surface of the substrate in the strip-shaped gaps; and
S3, removing the carbon nanotube structure to obtain a plurality of catalyst strips on the surface of the substrate; and
S4, growing a plurality of graphene strips on the plurality of catalyst strips.

12. The method of claim 11, wherein in step S1, the substrate has a thickness in a range from about 100 nanometers to about 100 micrometers.

13. The method of claim 12, wherein the substrate is made of silicon, silicon dioxide, silicon carbide, quartz, or glass.

14. The method of claim 11, wherein a width of the strip-shaped gaps is in a range from about 20 nanometers to about 80 nanometers.

15. The method of claim 11, wherein the at least one drawn carbon nanotube film of the carbon nanotube structure comprises a plurality of drawn carbon nanotube films stacked with each other.

16. The method of claim 15, wherein each of the plurality of drawn carbon nanotube films is made by:
providing a carbon nanotube array;
selecting a carbon nanotube segment having a predetermined width from the carbon nanotube array; and
pulling the carbon nanotube segment at a uniform speed to form one of the at least one drawn carbon nanotube films which is uniform.

17. The method of claim 11, wherein in step S2, the catalyst material is copper (Cu), nickel (Ni), iridium (Ir), ruthenium (Ru), or molybdenum (Mo).

18. The method of claim 17, wherein in step S2, the catalyst layer is formed by a sputtering or evaporating method.

19. The method of claim 11, wherein the plurality of catalyst strips has the same pattern as the strip-shaped gaps.

20. The method of claim 11, wherein step S4 comprises steps of:
S41, placing the substrate in a reacting chamber;
S42, heating the substrate to a predetermined temperature; and
S43, flowing a carbon source gas into the reacting chamber, thereby forming graphene strips on a surface of the catalyst strip.
